(19) United States
(12) Patent Application Publication
(10) Pub. No.: US 2006/0012995 A1
(43) Pub. Date: Jan. 19, 2006

(54) Light fitting

(76) Inventor: Robert Henry Tillotson, Leeds (GB)

Correspondence Address: VENABLE LLP, P.O. BOX 34385, WASHINGTON, DC, 20045-9998, US

(21) Appl. No.: 10/517,662

(22) PCT Filed: Jun. 12, 2003
(86) PCT No.: PCT/GB03/02537

§ 371 Date: Aug. 25, 2005

(30) Foreign Application Priority Data
Jun. 13, 2002 (GB) 0213550.7

(51) Int. Cl. F21V 33/00

(52) U.S. Cl. 362/253

(57) ABSTRACT

A fluorescent lamp (10) is located within a coloured sleeve (12), the body of the latter being made of translucent material. A drive cap (14) of the sleeve (12) is driven by a belt (16), movement of which causes rotation of the sleeve over the fluorescent lamp (10).

This invention relates to a light fitting, more particularly, but not limited to, a light fitting for providing variable colour output, and to a method of providing variable light colour output from a light fitting.

Various attempts have been made to obtain a variable colour light output from a lamp, such as a gas discharge lamp. Although these examples provide variable light colour they are very costly to produce and consequently very expensive. Poor light output is also a problem.

It is an object of the present invention to address the above disadvantage.

According to a first aspect of the invention a lighting system comprises at least one lamp, a power control for the or each lamp, cover means for the or each lamp and control means, wherein the or each cover means is adapted to substantially surround a respective lamp and the control means are operable to move the or each cover means relative to their respective lamps, and wherein the or each cover means is operable to receive removable strips to alter the colour of light transmitted by the or each cover means.

Preferably, the cover means is a sleeve, preferably an at least partially translucent sleeve, preferably having open ends. The cover means is preferably tubular.

The cover means preferably comprises two sleeves, being inner and outer sleeves.

The inner sleeve may be generally square in cross-section. The outer sleeve may be generally circular in cross-section. Pockets may be formed between inner and outer sleeves, which pockets are adapted to receive inserts, preferably coloured inserts. The inserts may be strips.

The inner sleeve may comprise abutting wall elements, which when located in the outer sleeve are held together to form the inner sleeve. The wall elements may form a sleeve of generally circular cross-section. The wall elements may form a sleeve of generally rectilinear or square cross-section.

The control means may comprise a driver and a motor, preferably a stepper motor. The driver may receive synchronisation signals from synchronisation means.

The lighting system may comprise a plurality of lamps, and a plurality of cover means, each lamp having control means, wherein the control means are preferably operable to receive synchronising signals from synchronisation means, to cause motors of the control means to turn the cover means in concert.

Preferably, the control means are operable to turn the cover means, preferably about a longitudinal axis thereof.

The lamp and power control may be a standard fluorescent lamp and associated control apparatus. The lamp is preferably tube-shaped. The lamp may be half-silvered.

The control means may comprise a motor which may be an integral motor. The motor may drive a drive belt. The drive belt may be arranged, in use, to engage the cover means. The control means may be operable to drive the cover means at different speeds.

The drive belt is preferably adapted to engage a drive portion of the cover means, which drive portion may be a drive cap located at one end of the cover means.

The cover means is preferably tube-shaped, preferably having a generally circular cross-section, preferably to allow rotation thereof over the lamp.

The cover means preferably has a body section, which may extend substantially along the length of the cover means, that is translucent to allow light from the lamp to pass therethrough.

The body section of the cover means may have differently coloured sections, to allow the colour of light issuing from the lighting system to vary as the cover means moves relative to the lamp.

The differently coloured sections may be strips, which may extend longitudinally along the cover means.

The body section may incorporate a spectrum of differently coloured strips arranged around the cover means, preferably to allow a substantially complete visible spectrum to be viewed by substantially one rotation of the cover means with respect to the lamp.

The differently coloured sections may be receivable in at least one pocket of the body section, which at least one pocket may be adapted to have a strip inserted therein. More than one colour of strip may be inserted into said pocket, preferably in order to change the colour of the light shining therethrough in use. A number of the pockets may be arranged around the outer surface of the cover means, preferably extending along the length thereof.

The body section of the cover means may be made of a coloured translucent/transparent material. The body section may be made of a clear translucent/transparent material having a coloured medium applied thereto, potentially by a printing technique.

According to a second aspect of the invention there is provided a cover means as described in relation to the first aspect.

The invention extends to a kit comprising cover means and control means as described in the first aspect. The kit is preferably adapted to be retrofitted to an existing lamp.

The invention extends to education apparatus comprising a light fitting according to the first aspect having cover means to selectively cover part of the lamp.

According to a third aspect of the invention a method of varying the colour of light output from a lamp comprises placing at least partially translucent cover means over a lamp to substantially surround the lamp and moving the cover means relative to the lamp, wherein the or each cover means is operable to receive removable strips to alter the colour of light transmitted by the or each cover means.

According to a further aspect of the invention a lighting system comprises a lamp, power control for the lamp, cover means for the lamp and control means, wherein the cover means is adapted to substantially surround the lamp and the control means are operable to move the control means relative to the lamp.

The cover means is preferably a sleeve placed over the lamp and preferably has an axis generally parallel to an axis of the lamp. The cover means is preferably rotated around a substantially longitudinal axis thereof.

All of the features described herein may be combined with any of the above aspects, in any combination.

For a better understanding of the invention and to show how the same may be brought into effect, specific embodiments will now be described, only by way of example, with reference to the accompanying drawings, in which:

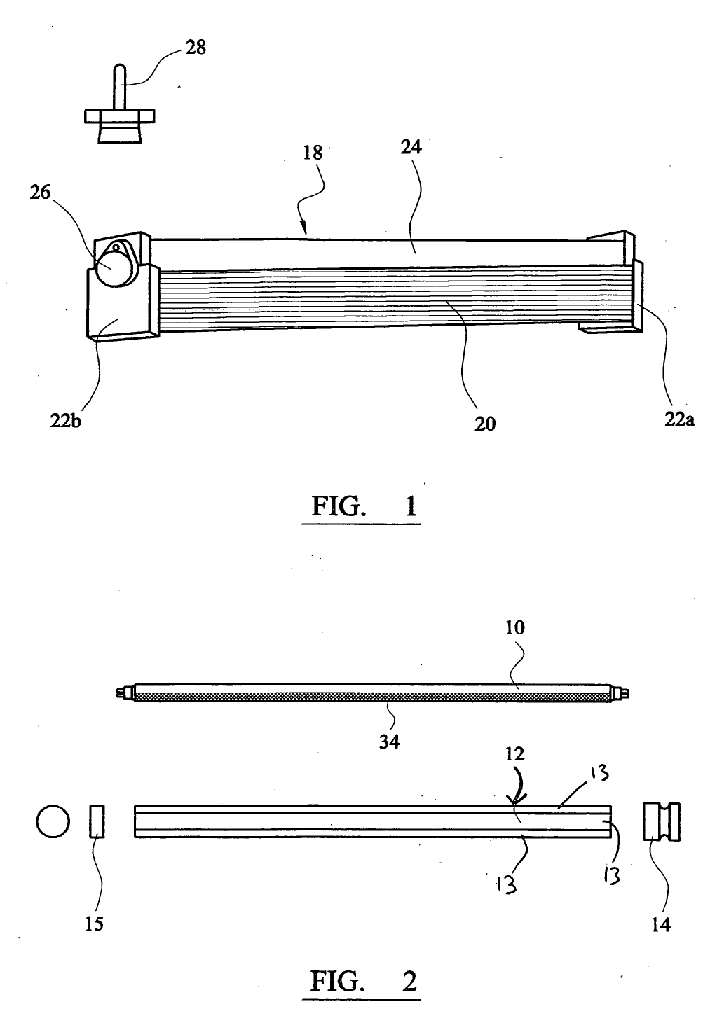

FIG. 1 is a schematic perspective exploded view of a standard luminaire for a fluorescent lamp with a motor fitted at one end thereof;

FIG. 2 is a schematic exploded diagram showing a fluorescent lamp tube, a coloured sleeve for placing over the tube, a first end cap of the sleeve and a second, drive, end cap of the sleeve;

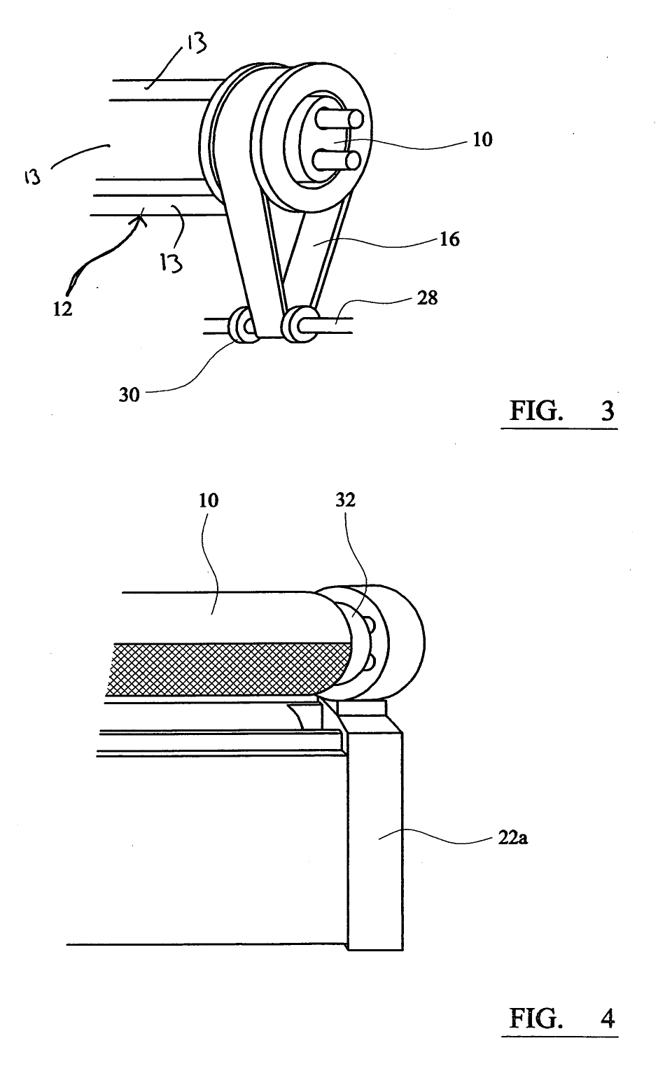

FIG. 3 shows a partial schematic perspective view of a drive system for the coloured sleeve placed over the fluorescent tube;

FIG. 4 shows a partial schematic side view of an end section of a standard fluorescent lamp fitting;

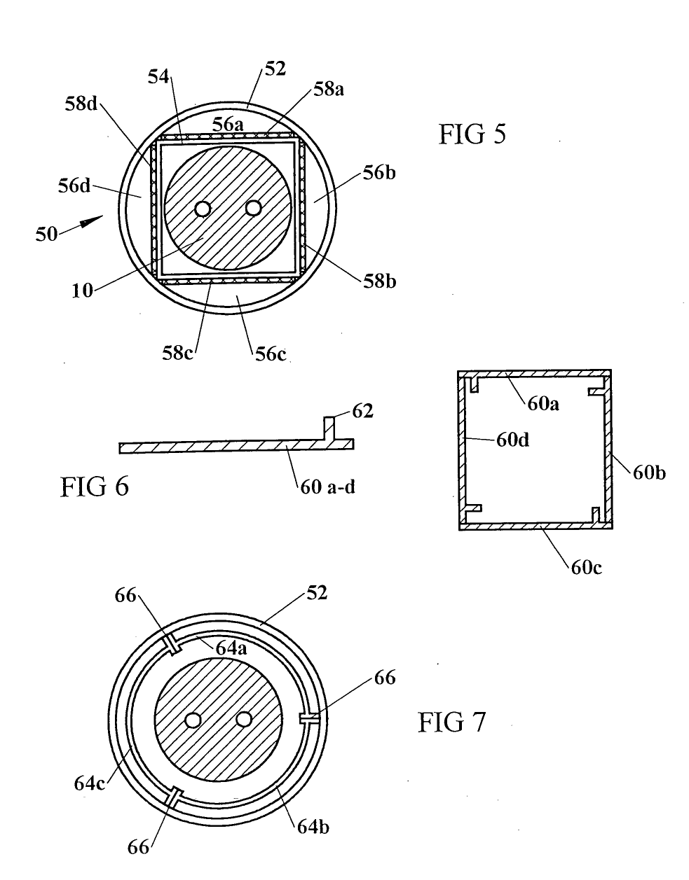

FIG. 5 is a schematic cross-section of an alternative embodiment of coloured sleeve with removable inserts;

FIG. 6 is a schematic cross-section and individual view of a partial alternative arrangement for FIG. 5;

FIG. 7 is a schematic cross-sectional view of an alternative arrangement to that in FIG. 5; and

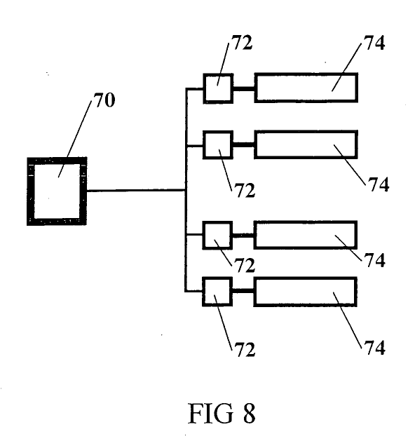

FIG. 8 is a schematic diagram showing a control system for synchronising a plurality of rotatable coloured lighting sleeves.

A fluorescent lamp tube 10 (see FIG. 2) is located within a coloured sleeve 12, the body of the latter being made of translucent material. A drive cap 14 of the sleeve 12 is driven by a drive belt 16 (see FIG. 3), movement of which causes rotation of the sleeve 12 over the fluorescent lamp tube 10. As the sleeve 12 rotates variations in the colour in the translucent material cause variations in the colour of the light transmitted into a surrounding environment.

In more detail, a standard fluorescent lamp tube luminaire 18, as shown in FIG. 1, has a cover 20, end caps 22a and 22b and body 24, for housing the electrical and electronic parts of the luminaire. In this embodiment, a motor 26 is secured in the end plate 22b, with a drive shaft 28 thereof (see FIG. 3 and in exploded view in FIG. 1) extending into the luminaire 18. The drive shaft may be approximately 5 cm long. The motor 26 may turn the drive shaft 28 at a speed of approximately 50 rpm.

As shown in FIG. 3, the drive shaft 28 is engaged by the drive belt 16, the drive shaft 28 extends generally parallel to the length of the fluorescent lamp 10 in its normal orientation in the luminaire 18.

The drive cap 14 on the coloured sleeve 12 has peripheral rims in which to receive and retain the drive belt 16. The drive shaft 28 similarly has retaining means 30 for the drive belt 16 to prevent lateral movement of the drive belt 16 along the drive shaft 28 during rotation thereof.

The drive cap 14 may be made of nylon or neoprene or another low friction material to allow relative movement of the drive cap 14 and the coloured sleeve 12 over the fluorescent lamp 10, which would typically be made predominantly of glass. Alternatively, the drive cap 14 may bear against a metal end section 32 (see FIG. 4) of the fluorescent lamp 10. An end cap 15 at the opposite end of the coloured sleeve 12 to the drive cap 14 may also be made of nylon to provide low friction relative movement between the sleeve 12 and the fluorescent lamp 10. The drive cap 14 may be integral and/or may be placed inside the sleeve 12. The drive cap 14 may be the same shape as the end cap 14 and may have an inner flange to bear against the glass part of the fluorescent lamp 10.

The coloured sleeve 12 may have a body section between the drive cap 14 and the end cap 15 which is made of plastics material, such as PVC or acrylic for example. The body material may be itself coloured to allow transmission of light of a given a colour therethrough, for example red, yellow or blue light. Alternatively, the body of the sleeve 12 may be colourless with coloured ink, pigment or the like applied thereto, for example by a printing process. Alternatively, coloured plastics material may be secured to the body with adhesive. A further alternative is to provide pockets running along the length of the sleeve 12 into which coloured material, such as plastics material, may be inserted to provide the colour for the sleeve 12.

The coloured sleeve 12 may provide a single colour, or more preferably, a plurality of colours, as shown in FIG. 3, in which longitudinal strips 13 of red, yellow and blue colour are provided. A further alternative would be to provide a spectrum of colour changing steadily through the visible spectrum around the circumference of the sleeve. The colour may also change along the length of the sleeve 12, by suitable printing or changes in material.

In use, a gearing ratio of perhaps 3 to 1 is provided between the narrow drive shaft 28 and the drive cap 14, such that a generally slow rotation of the sleeve 12 is seen. Thus, using the example of the sleeve 12 in FIG. 2, which has equal sections of red, yellow and blue colouring a period of red coloured light would be emitted by the sleeve 12 followed by a smooth transition to a yellow colour and then a smooth transition to a blue colour and back to red. The variation in colour in this way provides a pleasing visual effect, which may also be relaxing, given correct selection of the transition between colours and the correct selection of the colours. The predominant colour transmitted at any one time is that adjacent the section of lamp directed away from the body 24 of the luminaire 18. Also, the fluorescent lamp 10 may have a silvered underside 34, as shown in FIG. 2 and a white translucent upperside to provide a good spectrum of light. Using the half-silvered tube 10 allows the light emitted from the sleeve 12 to be directed away from the body 24 of the luminaire.

In addition to the retaining means 30 shown in FIG. 3, different sizes of retaining means 30 could be provided on the drive shaft 28, in order to provide different gearing ratios between the drive shaft 28 and the drive cap 14. This provides different speeds of rotation of the sleeve 12 and so provides different visual effects.

As well as the aesthetic uses mentioned above, the coloured sleeve 12 mentioned above that is provided with a spectrum of colour may be used in order to select a particular colour, either in selecting colours for fashion items such as clothing, or to select the colour of interior, or exterior, surfaces in a building, during decorating. In order to achieve this, the full spectrum coloured sleeve is rotated using the system described above. The colour transmitted by the sleeve using the half-silvered tube 10 will change continuously at a given point as the sleeve rotates. A user can select the required colour by stopping the rotation of the motor 26 when a preferred colour is found.

A remote control device may be provided to start and stop the motor 26.

A further alternative to those described above would be to provide a plurality of the luminaires shown in FIG. 1 having the coloured sleeve 12 and drive system described. The luminaires could be arranged to rotate the sleeve 12 in each of the luminaires at the same speed with the same transitions between colours to provide a much greater area of coloured illumination.

A double luminaire may also be provided. One lamp in the double luminaire may be a simple white lamp, whilst another lamp may have the coloured sleeve 12 and drive system for providing coloured effects. With that system a user may select standard illumination with the white tube 10 or variable colour illumination with the sleeve 12.

Following on from the reference above to the provision of pockets running along the length of the sleeve 12 into which coloured material, such as plastics material, may be inserted, FIGS. 5, 6 and 7 show further, more detailed, alternatives for the provision of removable coloured sections in association with the sleeve 12.

The working of the embodiments in relation to the provision of a rotatable sleeve is much the same as described in relation to the embodiments above and the same reference numerals have been used for like parts.

In FIG. 5 the fluorescent tube 10 is shown surrounded by a different type of sleeve 50. The sleeve 50 comprises a clear outer tube 52 having a generally circular cross-section. A clear inner tube 54 of generally square cross-section is located within the clear outer tube 52 such that corners of the inner square tube 54 contact the outer tube 52. Four segments 56a-d are defined by each of the straight sides of the inner square tube 54 and the points that they contact the outer clear tube 52. Each of the sectors 56a-d forms a pocket. In each of these pockets a film insert 58a-58d is placed. The film insert may be of coloured material of a user's choosing and may be replaced by withdrawing a film insert from one end of the sleeve 50 and replacing it from that end with another insert. Thus, the segmental pockets 56a-56d retain the film inserts 58a-58d.

By suitable choice of size of the film inserts 58a-58d it can be ensured that they extend right across the width of the pockets 56a-56d, making it possible to achieve complete or almost complete colour from the lamp with little or no gap between inserts. The engagement of the corners of the inner square tube 54 with the outer circular tube 52 will form thin lines along the length of the sleeve 50, where the two tubes are secured together.

Both of the inner and outer tubes 54 and 52 may be produced by an extrusion process. The inner tube 54 may be secured within the outer tube 52 by adhesive, or alternatively may be held in position by a friction fit.

The inner and outer tubes 54 and 52 may be made of polycarbonate or acrylic or other suitable clear material that can be formed into the required shapes.

The sleeve 50 has a length chosen to extend along the length of the light emitting portion of the fluorescent tube 10.

FIG. 6 shows an alternative example for the inner square tube 54 shown in FIG. 5. Instead of a square extrusion, four identical strips 60a-d are provided, which are assembled to form a tube of square cross-section.

The strips 60a-d each incorporate a flange 62 which, as shown in FIG. 6 is placed in abutting engagement with an adjacent strip held at 90° thereto. Each flange 62 abuts a main part of an adjacent strip. With the strips held in the arrangement shown in FIG. 6 they can be inserted into the outer tube 52. Alternatively, the strips 60a-d may be assembled in the outer tube 52.

Inserts 58a-d can be inserted in the remaining openings 56a-d in the same way as described in relation to FIG. 5.

A further alternative arrangement for using coloured inserts is shown in FIG. 7. In that Figure a clear outer tube 52 of circular cross-section is used together with coloured inserts 64a,b and c. The inserts each have a length approximately equal to the length of the clear tube, which itself has a length appropriate to the light emitting portion of the fluorescent tube 10. Along the sides of each insert 64a-c is a flange 66.

The inserts 64a-c are placed into the outer tube 52 and are curved to follow the shape of the interior of the clear outer tube 52. The inserts 64a, b, and c engage with each other by means of the flanges 66 and, by pushing against each other are held in a generally circular arrangement against the inside of the outer tube 52. Pressure is exerted between neighbouring flanges 66 to retain the curved shape of the inserts, which together form a tube with generally circular cross-section when held in position.

The embodiments described above may be driven in the same way as the earlier embodiments described in relation to FIGS. 1 to 4. Thus, a drive belt engages the outer tube 52, or an extension thereof and the drive belt is driven by a drive shaft of a motor. The drive belt 16 may be tensioned by means of suitable spring loading, such as locating the motor on a sprung bed.

An alternative drive mechanism dispenses with a drive belt and uses gearing which directly engages a gear on or associated with the sleeve 50. Gearing from a drive motor may engage the sleeve gear by means of usual well known methods for reducing the speed of rotation to an amount suitable for rotation of the sleeve 12. A reduction ratio in the region of 5:1 is envisaged.

Drive motors that may be used in the gearing system may be of the stepper motor type which typically uses a 12v direct current power supply. Advantages are provided in safety terms by stepper motors in view of the lower voltage required to drive them.

Also, as shown in FIG. 8 speeds can be controlled from a separate main unit 70 via a driver 72 attached to each luminaire/light fitting 74. The main unit 70 may be a pulse generator which would supply the same pulses to each driver 72 associated with each of the luminaires/light units 74 to provide synchronisation of the stepper motors for colour changes which act in concert as the sleeves 50 on each of the separate luminaires 74 rotate.

Signals from the pulse generator 70 via the drivers 72 are used to provide the stepper motors 72 with signals to change speed and also to synchronise speeds of the motors so that lighting changes over a wide area can be synchronised.

The embodiments described above have significant advantages in that a user may change the colour of the light emitted by the sleeve 50 by simply replacing the coloured inserts. Such replacement would not require removal of the lighting tube 10, which consequently has advantages for the amount of time it would take to change a system. Also, advantages result from the possibility of replacing damaged colour inserts.

The synchronisation aspects provided in relation to the stepper motors described or receiving synchronising signals from a central unit are also advantageous when it is desired to provide changing lighting effects in larger areas where a number of lights or luminaires are required.

Educational uses for the system can also be envisaged. Where a red, blue and green coloured sleeve is provided and is used with a tube 10 having no silvering so that light emitted from the tube causes all three of the red, blue and yellow lights to be emitted at some point around the circumference of the tube. The effect whereby the colours of the light combine to produce white light can be used to demonstrate to students the combination of different light colours leading to different coloured light, or leading to white light, when the combination of red, yellow and blue is used. This effect can also be shown by inserting different coloured strips into the pockets mentioned above. By having a spiral arrangement of red, yellow and blue strips (none overlapping), it can be shown that the light emitted combines to produce white light. A lamp 10 may have a part with a spiral arrangement and the longitudinal strips described above, to show the difference between the light outputs, i.e. white from the spiral and the particular colour exposed from the other. A box may be provided with a sliding cover to selectively reveal one side or the other.

The system described above for providing lighting which changes colour over time has aesthetic benefits and may also be used to create a particular mood. The transition between different colours may be adjusted by selecting different colour transitions on the sleeve, or by selecting different speeds of rotation for the sleeve.

Using the sleeve 12 which has pockets along its length, different types of colour transition can be selected by a user by differently coloured strips, or even using the same coloured strips to provide the same colour continuously, even whilst the sleeve 12 is rotating.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A lighting system comprises at least one lamp, a power control for the or each lamp, cover means for the or each lamp and control means, wherein the or each cover means is adapted to substantially surround a respective lamp and the control means are operable to move the or each cover means relative to their respective lamp, wherein the cover means is a sleeve, wherein the or each cover means is operable to receive removable strips to alter the colour of light transmitted by the or each cover means, and wherein the cover means is in contact with the respective lamp.

2. A lighting system as claimed in claim 1, in which the covers comprises two sleeves, being inner and outer sleeves.

3. A lighting system as claimed in claim 2, in which the inner sleeve is generally square in cross-section.

4. A lighting system as claimed in either claim 2 or claim 3, in which the outer sleeve is generally circular in cross-section.

5. A lighting system as claimed in any one of claims 2 to 4, in which pockets are formed between the inner and outer sleeves.

6. A lighting system as claimed in claim 5, in which the pockets are adapted to receive inserts.

7. A lighting system as claimed in any one of claims 2 to 6, in which the inner sleeve comprises abutting wall elements which, when located in the outer sleeve, are held together to form the inner sleeve.

8. A lighting system as claimed in claim 7, in which the wall elements form a sleeve of generally circular cross-section.

9. A lighting system as claimed in claim 7, in which the wall elements form a sleeve of generally rectilinear or square cross-section.

10. A lighting system as claimed in any preceding claim, in which the control means comprise a driver and a motor.

11. A lighting system as claimed in any preceding claim, which comprises a plurality of lamps, and a plurality of cover means, each lamp having control means.

12. A lighting system as claimed in claim 11, in which the control means are operable to receive synchronising signals from synchronisation means, to cause motors of the control means to turn the cover means in concert.

13. A cover means according to any one of claims 1 to 12.

14. A kit comprising cover means and control means as described in any one of claims 1 to 12.

15. Education apparatus comprising a lighting system according to any one of claims 1 to 12 having cover means to selectively cover part of the lamp.
